(19) United States
(12) Patent Application Publication
(10) Pub. No.: US 2024/0213582 A1
(43) Pub. Date: Jun. 27, 2024

(54) Thermal Management System for Fuel Cell Electric Vehicle

(71) Applicants: Hyundai Motor Company, Seoul (KR); Kia Corporation, Seoul (KR)

(72) Inventor: Jungmin Seo, Suwon-si (KR)

(21) Appl. No.: 18/325,715

(22) Filed: May 30, 2023

(30) Foreign Application Priority Data
Dec. 26, 2022 (KR) 10-2022-0184234

(51) Int. Cl. H01M 10/663; H01M 8/0267; H01M 8/04007; H01M 8/04029; H01M 10/625; H01M 10/6569; H01M 16/00

(52) U.S. Cl. CPC H01M 10/663; H01M 8/0267; H01M 8/04029; H01M 8/04074; H01M 10/625; H01M 10/6569; H01M 16/006; H01M 2220/20; H01M 2250/20

(57) ABSTRACT

An embodiment thermal management system for a fuel cell electric vehicle includes a stack cooling apparatus including a first line for circulating a first coolant, an electrical component cooling apparatus including a second line for circulating a second coolant, an electrical component on the second line, a battery cooling apparatus including a third line for circulating a third coolant, a heat-exchanger, a battery, and a chiller on the third line, wherein the chiller is connected through a refrigerant line and a first refrigerant connection line of an air conditioner unit and is configured to adjust a temperature of the third coolant by heat-exchanging the third coolant drawn through the third line with a refrigerant from the air conditioner unit through the first refrigerant connection line, a heating apparatus including a heating line for circulating a fourth coolant, and a heater core on the heating line.

### CROSS-REFERENCE TO RELATED APPLICATIONS

This application claims the benefit of Korean Patent Application No. 10-2022-0184234, filed on Dec. 26, 2022, which application is hereby incorporated herein by reference.

### TECHNICAL FIELD

The present disclosure relates to a thermal management system for a fuel cell electric vehicle.

### BACKGROUND

A fuel cell stack is an energy conversion system that converts the chemical energy of fuel directly into electrical energy by generating electrical power as part of a chemical reaction between an electrolyte and gas of diesel or industrial fuel. Unlike general batteries, fuel cells do not require recharging and provide a power generating system that may continuously generate electricity as long as fuel is supplied.

A fuel cell stack has an electrolyte and two electrodes overlapped like a sandwich, and when oxygen and hydrogen flow to the electrodes, electricity, heat, and water are generated. The fuel cell stack is used as a system for supplying power to electric vehicles or fields that are not practically utilized such as a spacecraft.

Various fuels such as natural gas, methanol, and gasoline may be used in the fuel cell stack, and the fuel is reformed into hydrogen using a fuel reformer prior to being used.

Meanwhile, with growing interest in energy efficiency and environmental pollution, it is expected that an electric vehicle using a fuel cell stack may substantially replace an internal combustion engine vehicle.

A fuel cell electric vehicle, which is an environment-friendly vehicle, refers to a vehicle using a fuel cell using an electrochemical reaction between hydrogen and oxygen as an electricity supply source and driving a motor with electricity generated by the fuel cell.

Such a fuel cell electric vehicle (FCEV) includes a fuel cell stack for generating electricity through a chemical reaction and a battery for storing electricity generated by the fuel cell stack.

Here, the fuel cell stack converts the chemical reaction energy of oxygen and hydrogen into electrical energy, and in this process, thermal energy is generated by chemical reactions within the fuel cell. Accordingly, effectively removing the generated heat is essential for ensuring the performance of the fuel cell.

That is, cooling and heating of the fuel cell stack and the battery are necessary to maintain a normal operation temperature. Here, the cooling and heating of the fuel cell stack and battery may be made by the coolant circulating the fuel cell stack and the coolant circulating the battery, and the respective coolants may be supplied from a stack cooling apparatus and a battery cooling apparatus.

Meanwhile, a fuel cell electric vehicle includes an air conditioner unit that circulates a refrigerant to heat or cool the vehicle interior.

The air conditioner unit, which is to maintain the interior of the vehicle at an appropriate temperature regardless of a change in an external temperature to maintain a comfortable interior environment, is configured to heat or cool the interior of the vehicle by heat-exchange by a condenser and an evaporator in a process in which a refrigerant discharged by driving of a compressor is circulated back to the compressor through the condenser, a receiver drier, an expansion valve, and the evaporator.

Accordingly, a fuel cell electric vehicle is typically applied with a stack cooling apparatus, a battery cooling apparatus, and an electrical component cooling apparatus for suppressing heat generation of a fuel cell stack, an electrical component, and a battery, and also with a thermal management system including an air conditioner unit for temperature adjustment of the vehicle interior.

In addition, in a conventional fuel cell electric vehicle, an air conditioner unit is used for cooling of the vehicle interior, and a coolant of a high temperature is used for heating the vehicle interior.

However, such a conventional thermal management system for a fuel cell electric vehicle that includes a heating apparatus for heating the vehicle interior by using the high temperature coolant is configured as a separate closed circuit, in addition to the stack cooling apparatus, the battery cooling apparatus, the electrical component cooling apparatus, and the air conditioner unit, and the thermal management of the fuel cell electric vehicle becomes inefficient because those component apparatuses are not thermally interlinked.

In addition, the temperature of the coolant in the stack cooling apparatus having cooled the fuel cell stack is highest, and it is efficient to use it for heating of the vehicle interior. However, since the cleanliness of the coolant having passed through the fuel cell stack may not be ensured, it is difficult to use the coolant circulating the stack cooling apparatus for heating of the vehicle interior.

In addition, the size and weight of the cooling module disposed in the front of the vehicle is increased, and the layout of connection pipes for supplying the refrigerant and the coolant to the stack cooling apparatus, the battery cooling apparatus, the electrical component cooling apparatus, and the air conditioner unit becomes complex in the front of the vehicle.

The above information disclosed in this background section is only for enhancement of understanding of the background of embodiments of the invention, and therefore it may contain information that does not form the prior art that is already known to a person of ordinary skill in the art.

### SUMMARY

The present disclosure relates to a thermal management system for a fuel cell electric vehicle. Particular embodiments relate to a thermal management system for a fuel cell electric vehicle capable of using the waste heat of the fuel cell stack for adjusting a temperature of a battery and for heating of the vehicle interior.

Embodiments of the present disclosure provide a thermal management system for a fuel cell electric vehicle capable of using the waste heat of the fuel cell stack for adjusting a temperature of a battery and for heating of the vehicle interior.

A thermal management system for a fuel cell electric vehicle may include a stack cooling apparatus including a first line through which a first coolant circulates, an electrical component cooling apparatus including a second line through which a second coolant circulates, an electrical component provided on the second line, a battery cooling apparatus that may include a third line through which a third coolant circulates, a battery provided on the third line, a chiller provided on the third line, connected through a refrigerant line and a first refrigerant connection line of an air conditioner unit, and configured to adjust a temperature of the third coolant by heat-exchanging the third coolant drawn through the third line with a refrigerant supplied from the air conditioner unit through the first refrigerant connection line, a heating apparatus including a heating line through which a fourth coolant circulates for heating a vehicle interior by using the fourth coolant, and a heater core provided on the heating line, where the stack cooling apparatus and the battery cooling apparatus are connected to the first line in order to selectively heat-exchange the first coolant supplied from the stack cooling apparatus through the first line with the third coolant circulating along the third line and are thermally interlinked with each other through a heat-exchanger provided on the third line.

The air conditioner unit may include a compressor configured to compress the refrigerant, a first condenser connected to the compressor through the refrigerant line and configured to condense the refrigerant by heat-exchanging the refrigerant supplied from the compressor with the second coolant supplied from the electrical component cooling apparatus, a first expansion valve connected to the first condenser through the refrigerant line, and an evaporator connected to the first condenser through the refrigerant line and configured to evaporate the refrigerant by heat-exchanging the refrigerant supplied from the first condenser with ambient air.

The electrical component cooling apparatus may include a radiator provided on the second line, a first water pump provided on the second line between the radiator and the electrical component, a cooling fan disposed at a rear of the radiator, and a connection line of which a first end may be connected to the second line between the first water pump and the electrical component and a second end may be connected to the second line between the electrical component and the radiator and on which the first condenser is provided.

The air conditioner unit may further include a refrigerant valve provided on the refrigerant line between the compressor and the first condenser, a second refrigerant connection line connected to the refrigerant valve and configured to be selectively opened and closed by an operation of the refrigerant valve, a second condenser provided on the second refrigerant connection line, connected to the heating line, and configured to condense the refrigerant by heat-exchanging the refrigerant supplied through the second refrigerant connection line with the fourth coolant supplied from the heating line, and a second expansion valve provided on the first refrigerant connection line at an upstream side of the chiller.

In a heating mode of the vehicle interior, the refrigerant valve may open the second refrigerant connection line and may close the refrigerant line connected to the first condenser.

A second end of the second refrigerant connection line may be connected to the refrigerant line between the first condenser and the first expansion valve.

For cooling the battery by using the third coolant heat-exchanged with the refrigerant, the second expansion valve may expand the refrigerant drawn through the first refrigerant connection line and may flow the expanded refrigerant to the chiller.

The battery cooling apparatus may include a second water pump provided on the third line between the battery and the heat-exchanger, a first valve provided on the third line between the battery and the chiller, a first branch line of which a first end may be connected to the first valve and a second end may be connected to the third line between the battery and the second water pump, a second valve provided on the third line between the heat-exchanger and the chiller, and a second branch line of which a first end may be connected to the second valve and a second end may be connected to the third line between the second water pump and the heat-exchanger.

The first branch line may be selectively opened by an operation of the first valve in order to prevent a temperature of the battery from increasing above a target temperature.

The third coolant having passed through the chiller is diverted without passing through the battery.

When a requested heating temperature is low at the time of heating the vehicle interior, the second valve may close a portion of the third line connected to the heat-exchanger and may open the second branch line such that the battery cooling apparatus forms an independent closed circuit separately from the stack cooling apparatus.

A battery heater may be provided on the third line between the chiller and the first valve.

For increasing a temperature of the battery, the battery heater may be operated in order to heat the third coolant supplied to the battery along the third line.

A heating mode of the vehicle interior may include a first heating mode for increasing a temperature of the battery and for recollecting waste heat of a fuel cell stack and waste heat of the battery together, a second heating mode for recollecting the waste heat of the fuel cell stack, and a third heating mode for recollecting the waste heat of the battery.

In the first heating mode, the first branch line may be closed by an operation of the first valve, and the second branch line may be closed by an operation of the second valve.

In the second heating mode, the first branch line may be opened by an operation of the first valve, a portion of the third line connecting the first valve and the battery with reference to the first valve may be closed by the operation of the first valve, and the second branch line may be closed by an operation of the second valve.

In the third heating mode, the first branch line may be closed by an operation of the first valve, the second branch line may be opened by an operation of the second valve, and the second valve may close a portion of the third line connected to the heat-exchanger.

The chiller may be configured to, in the first heating mode, recollect the waste heat of the fuel cell stack and the battery from the third coolant heat-exchanged with the first coolant at the heat-exchanger. In the second heating mode, the chiller may be configured to recollect the waste heat of the fuel cell stack from the third coolant heat-exchanged with the first coolant at the heat-exchanger, and in the third heating mode, the chiller may be configured to recollect the waste heat of the battery from the third coolant heated while cooling the battery.

The heating apparatus may include a third water pump provided on the heating line between the second condenser and the heater core, a coolant heater provided on the heating line between the third water pump and the heater core and configured to selectively heat the fourth coolant circulating along the heating line, a third valve provided on the heating line between the second condenser and the third water pump, and a third branch line of which a first end may be connected to the third valve and a second end may be connected to the heating line connecting the heater core and the second condenser.

For heating the vehicle interior by using the coolant heater, the third valve may close a portion of the heating line connected to the second condenser and may open the third branch line.

According to the thermal management system for a fuel cell electric vehicle according to an embodiment, by using the waste heat of the fuel cell stack for adjusting a temperature of a battery and for heating of the vehicle interior, the temperature of the battery may be adjusted more rapidly, and the vehicle interior may be efficiently heated.

According to embodiments of the present disclosure, by applying the heat-exchanger for heat-exchange between the first and third coolants such that the stack cooling apparatus and the battery cooling apparatus are thermally interlinked, the heat generated by the fuel cell stack may be efficiently used. Accordingly, unnecessary power consumption may be reduced, and marketability may be enhanced.

In addition, according to embodiments of the present disclosure, by efficiently cooling the battery by using the chiller heat-exchanging the refrigerant and the third coolant, a radiator used for the battery in the conventional battery cooling apparatus may be removed, and thereby the overall system may be streamlined.

In addition, according to embodiments of the present disclosure, by using the waste heat of the fuel cell stack and the waste heat of the battery together for heating of the vehicle interior, the overall travel distance of the vehicle may be increased by the efficient temperature adjustment of the battery to ensure the optimal performance of the battery and to enhance the heating efficiency.

In addition, according to embodiments of the present disclosure, by streamlining the entire system, reduction of an overall manufacturing cost and a decrease in weight is enabled, and space utilization may be enhanced by minimizing the required components.

### BRIEF DESCRIPTION OF THE DRAWINGS

FIG. 1 is a block diagram of a thermal management system of a fuel cell electric vehicle according to an embodiment.

FIG. 2 is an operation diagram of a first heating mode of a thermal management system of a fuel cell electric vehicle according to an embodiment.

FIG. 3 is an operation diagram of a second heating mode of a thermal management system of a fuel cell electric vehicle according to an embodiment.

FIG. 4 is an operation diagram of a third heating mode of a thermal management system of a fuel cell electric vehicle according to an embodiment.

FIG. 5 is an operation diagram of a cooling mode of a thermal management system of a fuel cell electric vehicle according to an embodiment.

The following reference identifiers may be used in connection with the accompanying drawings to describe exemplary embodiments of the present disclosure.
10: stack cooling apparatus
11: first line
15: heat-exchanger
20: electrical component cooling apparatus
21: second line
22: radiator
23: cooling fan
24: electrical component
25: first water pump
26: connection line
30: battery cooling apparatus
31: third line
32: battery
33: second water pump
34: battery heater
35, 37: first and second valves
36, 38: first and second branch lines
40: air conditioner unit
41: refrigerant line
42: compressor
43, 44: first and second condensers
45: first expansion valve
46: evaporator
47: refrigerant valve
48: second refrigerant connection line
50: chiller
51: first refrigerant connection line
52: second expansion valve
60: heating apparatus
61: heating line
62: heater core
63: third water pump
64: coolant heater
65: third valve
66: third branch line

### DETAILED DESCRIPTION OF ILLUSTRATIVE EMBODIMENTS

Exemplary embodiments of the present invention will hereinafter be described in detail with reference to the accompanying drawings.

Exemplary embodiments disclosed in the present specification and the constructions depicted in the drawings are only the preferred embodiments of the present disclosure and do not cover the entire scope of the present disclosure. Therefore, it will be understood that there may be various equivalents and variations included within the scope of the present disclosure.

In order to clarify embodiments of the present disclosure, parts that are not related to the description will be omitted, and the same elements or equivalents are referred to with the same reference numerals throughout the specification.

Also, the size and thickness of each element are arbitrarily shown in the drawings, but the present disclosure is not necessarily limited thereto, and in the drawings, the thickness of layers, films, panels, regions, etc. are exaggerated for clarity.

In addition, unless explicitly described to the contrary, the word “comprise” and variations such as “comprises” or “comprising” will be understood to imply the inclusion of stated elements but not the exclusion of any other elements.

Furthermore, each of terms, such as “ . . . unit,” “ . . . means,” “ . . . portions,” “ . . . part,” and “ . . . member” described in the specification, mean a unit of a comprehensive element that performs at least one function or operation.

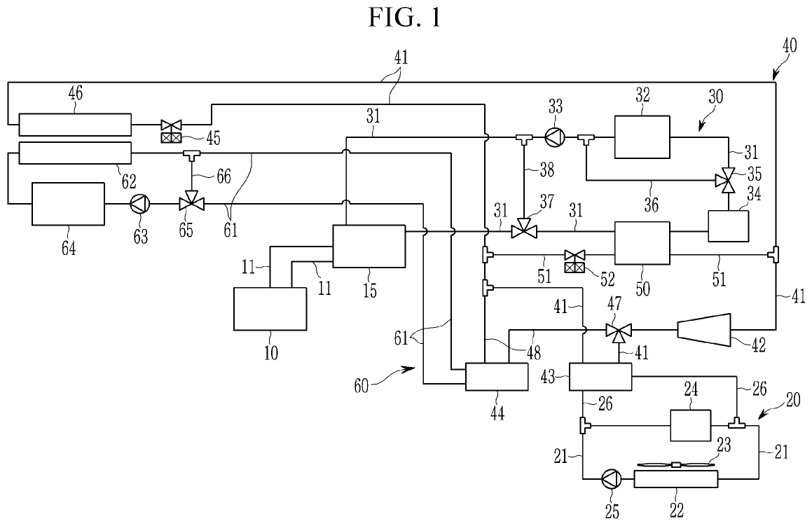

FIG. 1 is a block diagram of a thermal management system of a fuel cell electric vehicle according to an embodiment.

Referring to FIG. 1, a thermal management system for a fuel cell electric vehicle according to an embodiment may use waste heat of a fuel cell stack for adjusting a temperature of a battery 32 and for heating of the vehicle interior.

The thermal management system may include a stack cooling apparatus 10, an electrical component cooling apparatus 20, a battery cooling apparatus 30, an air conditioner unit 40, a chiller 50, and a heating apparatus 60.

First, the stack cooling apparatus 10 may include a first line 11 through which a first coolant circulates.

The stack cooling apparatus 10 may cool the fuel cell stack (not shown) by using the first coolant cooled at a radiator.

The stack cooling apparatus 10 may be connected to a heat-exchanger 15 through the first line 11.

That is, the first coolant circulating the stack cooling apparatus 10 may be selectively supplied to the heat-exchanger 15 by an operation of the stack cooling apparatus 10.

In the present embodiment, the electrical component cooling apparatus 20 may include a second line 21 through which a second coolant circulates and an electrical component 24 provided on the second line 21.

Here, the electrical component cooling apparatus 20 may further include a radiator 22, a cooling fan 23, and a first water pump 25.

The radiator 22 may be disposed in the front of the vehicle. The cooling fan 23 may be provided at a downstream side of the radiator 22. Accordingly, the radiator 22 may cool the second coolant through an operation of the cooling fan 23 and heat-exchange with an ambient air.

The first water pump 25 may be provided on the second line 21 between the radiator 22 and the electrical component 24.

In addition, the electrical component 24 may include an electric power control unit (EPCU), a motor, an inverter, or an on-board charger (OBC), and the like.

The electrical component cooling apparatus 20 may circulate a coolant to the second line 21 by an operation of the first water pump 25 such that the second coolant is supplied to the electrical component 24 provided on the second line 21.

In the present embodiment, the battery cooling apparatus 30 may include a third line 31 through which a third coolant circulates and the battery 32 provided on the third line 31.

Here, the battery cooling apparatus 30 may further include a second water pump 33, a battery heater 34, a first valve 35, a first branch line 36, a second valve 37, and a second branch line 38.

First, the second water pump 33 is for circulating the third coolant along the third line 31 and may be provided on the third line 31 between the battery 32 and the heat-exchanger 15.

Here, the heat-exchanger 15 may be connected to the first line 11 and provided on the third line 31 in order to selectively heat-exchange the first coolant supplied from the stack cooling apparatus 10 through the first line 11 with the third coolant circulating along the third line 31.

Accordingly, the stack cooling apparatus 10 may be thermally interlinked with the battery cooling apparatus 30 through the heat-exchanger 15.

The battery heater 34 may be provided on the third line 31 between the chiller 50 and the first valve 35.

That is, the battery heater 34 is operated when a temperature of the third coolant supplied to the battery 32 is lower than a target temperature and may heat the third coolant flowing along the third line 31.

Accordingly, the third coolant heated while passing through the battery heater 34 may be supplied to the battery 32 along the third line 31 and may increase the temperature of the battery 32.

Therefore, the battery heater 34 may be selectively operated to increase the temperature of the battery 32.

In the present embodiment, the first valve 35 is provided on the third line 31 between the battery 32 and the chiller 50.

A first end of the first branch line 36 may be connected to the first valve 35. A second end of the first branch line 36 may be connected to the third line 31 between the battery 32 and the second water pump 33.

Here, the first branch line 36 may be selectively opened by an operation of the first valve 35 in order to prevent the temperature of the battery 32 from increasing above the target temperature.

Accordingly, the first branch line 36 may divert the third coolant having passed through the chiller 50 without passing through the battery 32.

In the present embodiment, the second valve 37 may be provided on the third line 31 between the heat-exchanger 15 and the chiller 50.

In addition, a first end of the second branch line 38 may be connected to the second valve 37. A second end of the second branch line 38 may be connected to the third line 31 between the second water pump 33 and the heat-exchanger 15.

Here, when a requested heating temperature is low at the time of heating the vehicle interior, the second valve 37 may close a portion of the third line 31 connected to the heat-exchanger 15 and open the second branch line 38 such that the battery cooling apparatus 30 forms an independent closed circuit separate from the stack cooling apparatus 10.

In the present embodiment, the air conditioner unit 40 may include a compressor 42, a first condenser 43, a first expansion valve 45, and an evaporator 46 that are interconnected through a refrigerant line 41.

First, the compressor 42 may compress a refrigerant in a gas state and discharge the compressed refrigerant.

The first condenser 43 may be connected to the compressor 42 through the refrigerant line 41. The first condenser 43 may condense the refrigerant by heat-exchanging the refrigerant supplied from the compressor 42 with the second coolant supplied from the electrical component cooling apparatus 20.

Here, the first condenser 43 may be connected to the electrical component cooling apparatus 20 through a connection line 26.

A first end of the connection line 26 may be connected to the second line 21 between the first water pump 25 and the electrical component 24. A second end of the connection line 26 may be connected to the second line 21 between the electrical component 24 and the radiator 22.

Accordingly, the first condenser 43 may be a water-cooled heat-exchanger into which the second coolant is drawn through the connection line 26.

The first expansion valve 45 may be connected to the first condenser 43 through the refrigerant line 41. The first expansion valve 45 may expand the refrigerant drawn through the refrigerant line 41.

The first expansion valve 45 may be an electronic expansion valve configured to selectively expand the refrigerant while controlling the flow of the refrigerant.

In addition, the evaporator 46 is connected to the first condenser 43 through the refrigerant line 41 and evaporates the refrigerant by heat-exchanging the refrigerant supplied from the first expansion valve 45 with the ambient air.

The evaporator 46 may be provided in an interior of a heating, ventilation, and air conditioning (HVAC) module provided in the vehicle.

That is, in a cooling mode of the vehicle, the evaporator 46 may evaporate the refrigerant through heat-exchange with the ambient air. The ambient air cooled while passing through the evaporator 46 may flow into the vehicle interior to cool the vehicle interior.

The air conditioner unit 40 may further include a second condenser 44, a refrigerant valve 47, and a second refrigerant connection line 48.

First, the refrigerant valve 47 may be provided on the refrigerant line 41 between the compressor 42 and the first condenser 43.

In addition, a first end of the second refrigerant connection line 48 may be connected to the refrigerant valve 47. A second end of the second refrigerant connection line 48 may be connected to the refrigerant line 41 between the first condenser 43 and the first expansion valve 45.

The second refrigerant connection line 48 may be selectively opened and closed according to an operation of the refrigerant valve 47.

In addition, the second condenser 44 may be provided on the second refrigerant connection line 48. The second condenser 44 may be connected to a heating line 61 included in the heating apparatus 60.

The second condenser 44 may condense the refrigerant by heat-exchanging the refrigerant supplied through the second refrigerant connection line 48 with a fourth coolant supplied from the heating line 61.

In the present embodiment, the chiller 50 may be provided on the third line 31.

The chiller 50 may be connected to the refrigerant line 41 of the air conditioner unit 40 through a first refrigerant connection line 51 such that the refrigerant may be supplied from the air conditioner unit 40.

The chiller 50 may be a water-cooled heat-exchanger that heat-exchanges the interiorly introduced third coolant with respect to the refrigerant supplied from the air conditioner unit 40 through the first refrigerant connection line 51.

Here, the chiller 50 may adjust the temperature of the third coolant by heat-exchanging the selectively supplied third coolant with the refrigerant selectively supplied from the air conditioner unit 40.

The chiller 50 may be operated when cooling the battery 32 by using the third coolant heat-exchanged with the refrigerant supplied from the air conditioner unit 40 or when recollecting waste heat from the first coolant heated by the waste heat of the fuel cell stack and the third coolant heated by waste heat of the battery 32, selectively, for heating of the vehicle interior.

Here, the air conditioner unit 40 may further include a second expansion valve 52. The second expansion valve 52 may be provided on the first refrigerant connection line 51 at an upstream side of the chiller 50.

The second expansion valve 52 may be an electronic expansion valve configured to selectively expand the refrigerant while controlling the flow of the refrigerant.

For cooling the battery 32 by using the third coolant heat-exchanged with the refrigerant, the second expansion valve 52 may expand the refrigerant drawn through the first refrigerant connection line 51 and may flow the expanded refrigerant to the chiller 50.

That is, the second expansion valve 52 expands the condensed refrigerant discharged from the first condenser 43 or the second condenser 44 to decrease its temperature and then flows the refrigerant to the chiller 50, thereby further decreasing the temperature of the third coolant passing through an interior of the chiller 50.

Accordingly, the third coolant cooled while passing through the chiller 50 is supplied to the battery 32, thereby enabling more efficiently cooling.

In the present embodiment, the heating apparatus 60 may include the heating line 61 through which the fourth coolant circulates in order to heat the vehicle interior by using the fourth coolant and a heater core 62 provided on the heating line 61.

The heater core 62 may be provided in an interior of a heating, ventilation, and air conditioning (HVAC) module provided in the vehicle together with the evaporator 46.

Here, the heating apparatus 60 may further include a third water pump 63, a coolant heater 64, a third valve 65, and a third branch line 66.

First, the third water pump 63 may be provided on the heating line 61 between the second condenser 44 and the heater core 62. The third water pump 63 may circulate the fourth coolant along the heating line 61.

The coolant heater 64 is provided on the heating line 61 between the third water pump 63 and the heater core 62 and may selectively heat the fourth coolant circulating along the heating line 61.

Here, when a temperature of the fourth coolant supplied to the heater core 62 is lower than the target temperature in a heating mode of the vehicle, the coolant heater 64 is ON-operated to heat the fourth coolant circulating the heating line 61, and thereby the heated fourth coolant may be drawn into the heater core 62.

The coolant heater 64 may be an electrical heater operated by supply of power.

The third valve 65 may be provided on the heating line 61 between the second condenser 44 and the third water pump 63.

In addition, a first end of the third branch line 66 may be connected to the third valve 65. A second end of the third branch line 66 may be connected to the heating line 61 connecting the heater core 62 and the second condenser 44.

Here, for heating the vehicle interior by using the coolant heater 64, the third valve 65 may close a portion of the heating line 61 connected to the second condenser 44 and may open the third branch line 66.

In the thermal management system, the heating mode of the vehicle interior may include a first heating mode, a second heating mode, and a third heating mode.

The first heating mode and the second heating mode may be performed under a condition that the requested heating temperature of the vehicle interior is high. In addition, the third heating mode may be performed under a condition that the requested heating temperature of the vehicle interior is low.

Here, the first heating mode may be operated in order to increase the temperature of the battery 32 and to recollect the waste heat of the fuel cell stack and the waste heat of the battery 32 together and use it for heating of the vehicle interior.

The second heating mode may be operated in order to recollect the waste heat of the fuel cell stack and use it for heating of the vehicle interior.

In addition, the third heating mode may be operated in order to recollect the waste heat of the battery 32 and use it for heating of the vehicle interior.

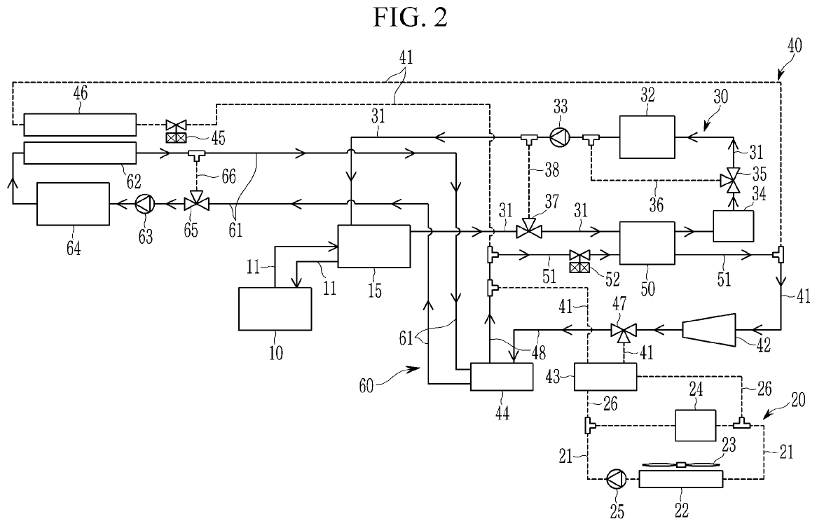

Hereinafter, operation and action of the thermal management system of a fuel cell electric vehicle according to an embodiment configured as described above is described in detail with reference to FIG. 2 to FIG. 5.

First, an operation in the first heating mode of a thermal management system for a fuel cell electric vehicle according to an embodiment for increasing the temperature of the battery 32 and for recollecting the waste heat of the fuel cell stack and the waste heat of the battery 32 together and using them for heating of the vehicle interior is described with reference to FIG. 2.

FIG. 2 is an operation diagram of a first heating mode of the thermal management system of a fuel cell electric vehicle according to an embodiment.

Referring to FIG. 2, in the first heating mode, the stack cooling apparatus 10 supplies the first coolant heated while cooling the fuel cell stack to the heat-exchanger 15 through the first line 11.

In the battery cooling apparatus 30, the third coolant may circulate along the third line 31 by an operation of the second water pump 33.

At this time, the first branch line 36 may be closed by the operation of the first valve 35. In addition, the second branch line 38 may be closed by an operation of the second valve 37.

That is, in the battery cooling apparatus 30, the third coolant heated while cooling the battery 32 may be drawn into the heat-exchanger 15.

Accordingly, the heat-exchanger 15 may heat-exchange the first coolant drawn through the first line 11 and the third coolant drawn through the third line 31, with respect to each other.

Here, the temperature of the first coolant having cooled the fuel cell stack having a large heat generation amount may be higher than the temperature of the third coolant having cooled the battery 32.

Therefore, the third coolant may be further heated through heat-exchange with the first coolant.

The third coolant heated at the heat-exchanger 15 flows into the battery 32 by passing through the chiller 50. Accordingly, the third coolant may rapidly increase the temperature of the battery 32.

Meanwhile, the electrical component cooling apparatus 20 may stop operating.

In addition, in the air conditioner unit 40, corresponding components may be operated to circulate the refrigerant.

Here, a portion of the refrigerant line 41 that connects the evaporator 46 and the first condenser 43 is closed. In addition, the first refrigerant connection line 51 may be opened by an operation of the second expansion valve 52.

In addition, the refrigerant valve 47 may open the second refrigerant connection line 48 such that the refrigerant supplied from the compressor 42 flows into the second condenser 44.

Then, the refrigerant supplied by the compressor 42 passes through the second condenser 44 along the second refrigerant connection line 48 connected to the refrigerant line 41.

Here, the heating apparatus 60 may operate the third water pump 63 such that the fourth coolant is supplied to the second condenser 44.

Accordingly, the fourth coolant may pass through the second condenser 44 along the heating line 61. At this time, the second condenser 44 may condense the refrigerant and heat the fourth coolant by heat-exchanging the fourth coolant circulating the heating line 61 and the high temperature refrigerant supplied from the compressor 42.

The heated fourth coolant flows into the heater core 62 by an operation of the third water pump 63.

Accordingly, the ambient air drawn from the outside may be converted into the high temperature state while passing through the heater core 62 and then discharged back to the vehicle interior, thereby achieving heating of the vehicle interior.

In addition, the refrigerant having passed through the second condenser 44 flows into the second expansion valve 52 along the opened first refrigerant connection line 51. The second expansion valve 52 may expand the refrigerant and supply it to the chiller 50.

The refrigerant having passed through the chiller 50 flows into the compressor 42 and may repetitively perform the above-described operations.

Meanwhile, the third coolant heated through heat-exchange with the first coolant having absorbed the waste heat of the fuel cell stack at the heat-exchanger 15 increases a temperature of the refrigerant supplied to the chiller 50 while passing through the chiller 50 by the operation of the second water pump 33.

That is, the chiller 50 may recollect the waste heat of the fuel cell stack and the battery 32 by evaporating the refrigerant supplied from the second condenser 44 through heat-exchange with the third coolant.

In other words, in the first heating mode, the chiller 50 may recollect the waste heat of the fuel cell stack and the battery 32 from the third coolant heat-exchanged with the first coolant at the heat-exchanger 15.

That is, in the first heating mode of the thermal management system according to the present embodiment, by increasing the temperature of the refrigerant by using the waste heat of the fuel cell stack and the waste heat of the battery 32, power consumption of the compressor 42 may be reduced, and heating efficiency may be enhanced.

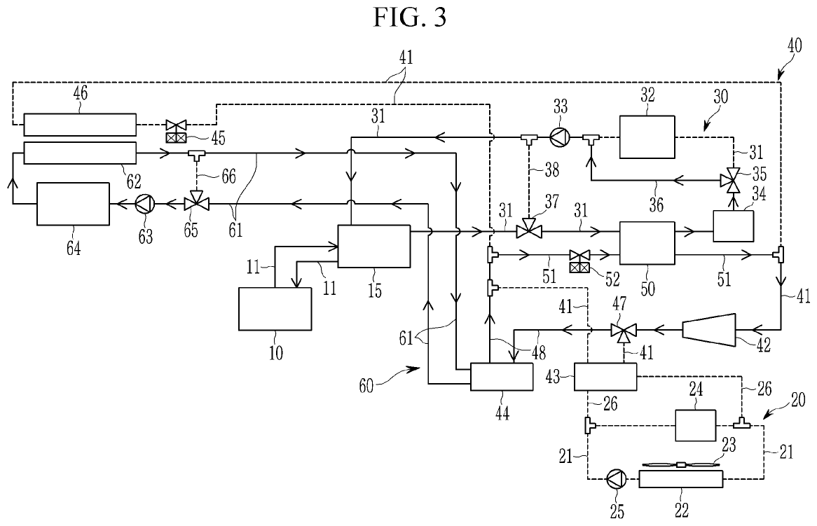

In the present embodiment, an operation in the second heating mode for recollecting the waste heat of the fuel cell stack and using it for heating of the vehicle interior is described with reference to FIG. 3.

FIG. 3 is an operation diagram of a second heating mode of the thermal management system of a fuel cell electric vehicle according to an embodiment.

Referring to FIG. 3, in the second heating mode, the stack cooling apparatus 10 supplies the first coolant heated while cooling the fuel cell stack to the heat-exchanger 15 through the first line 11.

In the battery cooling apparatus 30, the third coolant may circulate along the third line 31 by the operation of the second water pump 33.

At this time, the first branch line 36 is opened by the operation of the first valve 35. Accordingly, with reference to the first valve 35, the portion of the third line 31 connecting the first valve 35 and the battery 32 is closed by the operation of the first valve 35.

In addition, the second branch line 38 may be closed by the operation of the second valve 37.

That is, in the battery cooling apparatus 30, because the temperature of the battery 32 has been increased above the target temperature, the third coolant heat-exchanged at the heat-exchanger 15 may be blocked from being drawn.

Therefore, the third coolant passes through the heat-exchanger 15 by detouring the battery 32 along the third line 31 and the opened first branch line 36.

Accordingly, the heat-exchanger 15 may heat-exchange the first coolant drawn through the first line 11 and the third coolant drawn through the third line 31, with respect to each other.

Here, the temperature of the first coolant having cooled the fuel cell stack having a large heat generation amount may be higher than the temperature of the third coolant. Therefore, the third coolant may be further heated through heat-exchange with the first coolant.

The third coolant heated at the heat-exchanger 15 passes through the chiller 50 and then flows along the first branch line 36 without passing through the battery 32.

Meanwhile, the electrical component cooling apparatus 20 may stop operating.

In addition, in the air conditioner unit 40, corresponding components may be operated to circulate the refrigerant.

Here, the portion of the refrigerant line 41 that connects the evaporator 46 and the first condenser 43 is closed. In addition, the first refrigerant connection line 51 may be opened by the operation of the second expansion valve 52.

In addition, the refrigerant valve 47 may open the second refrigerant connection line 48 such that the refrigerant supplied from the compressor 42 is introduced into the second condenser 44.

Then, the refrigerant supplied by the compressor 42 passes through the second condenser 44 along the second refrigerant connection line 48 connected to the refrigerant line 41.

Here, the heating apparatus 60 may operate the third water pump 63 such that the fourth coolant is supplied to the second condenser 44.

Accordingly, the fourth coolant may pass through the second condenser 44 along the heating line 61. At this time, the second condenser 44 may condense the refrigerant and heat the fourth coolant by heat-exchanging the fourth coolant circulating the heating line 61 and the high temperature refrigerant supplied from the compressor 42.

The heated fourth coolant flows into the heater core 62 through the operation of the third water pump 63.

Accordingly, the ambient air drawn from the outside may be converted into the high temperature state while passing through the heater core 62 and then discharged back to the vehicle interior, thereby achieving heating of the vehicle interior.

In addition, the refrigerant having passed through the second condenser 44 flows into the second expansion valve 52 along the opened first refrigerant connection line 51. The second expansion valve 52 may expand the refrigerant and supply it to the chiller 50.

The refrigerant having passed through the chiller 50 flows into the compressor 42 and may repetitively perform the above-described operations.

Meanwhile, the third coolant heated through heat-exchange with the first coolant having absorbed the waste heat of the fuel cell stack at the heat-exchanger 15 passes through the chiller 50 by the operation of the second water pump 33 and heats the refrigerant supplied to the chiller 50.

That is, the chiller 50 may recollect the waste heat of the fuel cell stack by evaporating the refrigerant supplied from the second condenser 44 through heat-exchange with the third coolant.

In other words, in the second heating mode, the chiller 50 may recollect the waste heat of the fuel cell stack from the third coolant heat-exchanged with the first coolant at the heat-exchanger 15.

That is, in the second heating mode of the thermal management system according to the present embodiment, by using the waste heat of the fuel cell stack to heat the refrigerant, power consumption of the compressor 42 may be reduced, and heating efficiency may be enhanced.

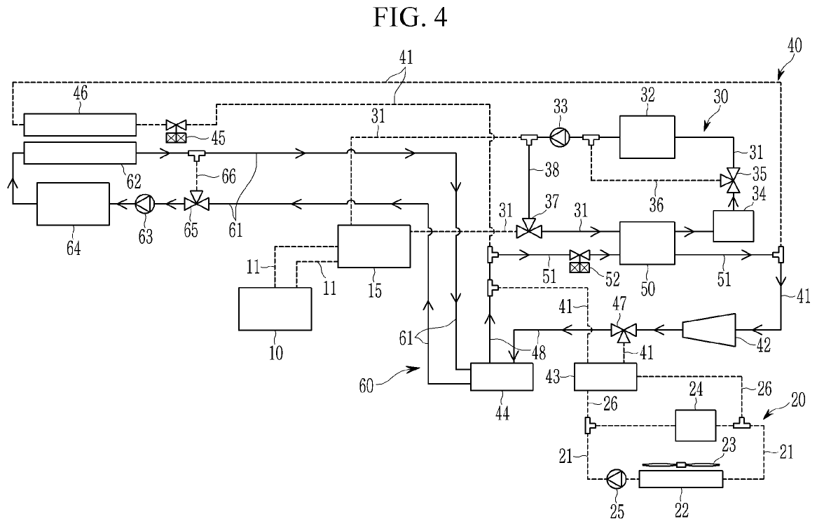

In the present embodiment, an operation in the third heating mode for recollecting the waste heat of the battery 32 and using it for heating of the vehicle interior is described with reference to FIG. 4.

FIG. 4 is an operation diagram of a third heating mode of the thermal management system of a fuel cell electric vehicle according to an embodiment.

Referring to FIG. 4, in the third heating mode, the stack cooling apparatus 10 closes the first line 11 such that the first coolant is not supplied to the heat-exchanger 15.

In the battery cooling apparatus 30, the third coolant may circulate along the third line 31 by the operation of the second water pump 33.

Here, the first branch line 36 is closed by the operation of the first valve 35. At the same time, the second branch line 38 is opened by the operation of the second valve 37.

In addition, the second valve 37 may close the portion of the third line 31 connected to the heat-exchanger 15.

Accordingly, the third coolant circulates along the opened third line 31 and the second branch line 38 without passing through the heat-exchanger 15.

That is, in the battery cooling apparatus 30, the third coolant heated while cooling the battery 32 may pass through the chiller 50.

Meanwhile, the electrical component cooling apparatus 20 may stop operating.

In addition, in the air conditioner unit 40, corresponding components may be operated to circulate the refrigerant.

Here, the portion of the refrigerant line 41 that connects the evaporator 46 and the first condenser 43 is closed. In addition, the first refrigerant connection line 51 may be opened by the operation of the second expansion valve 52.

In addition, the refrigerant valve 47 may open the second refrigerant connection line 48 such that the refrigerant supplied from the compressor 42 is introduced into the second condenser 44.

Then, the refrigerant supplied by the compressor 42 passes through the second condenser 44 along the second refrigerant connection line 48 connected to the refrigerant line 41.

Here, the heating apparatus 60 may operate the third water pump 63 such that the fourth coolant is supplied to the second condenser 44.

Accordingly, the fourth coolant may pass through the second condenser 44 along the heating line 61. At this time, the second condenser 44 may condense the refrigerant and heat the fourth coolant by heat-exchanging the fourth coolant circulating the heating line 61 and the high temperature refrigerant supplied from the compressor 42.

The heated fourth coolant flows into the heater core 62 through the operation of the third water pump 63.

Accordingly, the ambient air drawn from the outside may be converted into the high temperature state while passing through the heater core 62 and then discharged back to the vehicle interior, thereby achieving heating of the vehicle interior.

In addition, the refrigerant having passed through the second condenser 44 flows into the second expansion valve 52 along the opened first refrigerant connection line 51. The second expansion valve 52 may expand the refrigerant and supply it to the chiller 50.

The refrigerant having passed through the chiller 50 flows into the compressor 42 and may repetitively perform the above-described operations.

Meanwhile, in the battery cooling apparatus 30, the third coolant absorbs the waste heat of the battery 32 while circulating along the opened third line 31 and the second branch line 38 to be increased in temperature.

The heated third coolant is recollected while heating the refrigerant supplied to the chiller 50 while passing through the chiller 50 by the operation of the second water pump 33.

That is, the chiller 50 may recollect the waste heat of the battery 32 by evaporating the refrigerant supplied from the second condenser 44 through heat-exchange with the third coolant.

In other words, in the third heating mode, the chiller 50 may recollect the waste heat of the battery 32 from the third coolant heated while cooling the battery 32.

That is, in the third heating mode of the thermal management system according to the present embodiment, by using the waste heat of the battery 32 to heat the refrigerant, power consumption of the compressor 42 may be reduced, and heating efficiency may be enhanced.

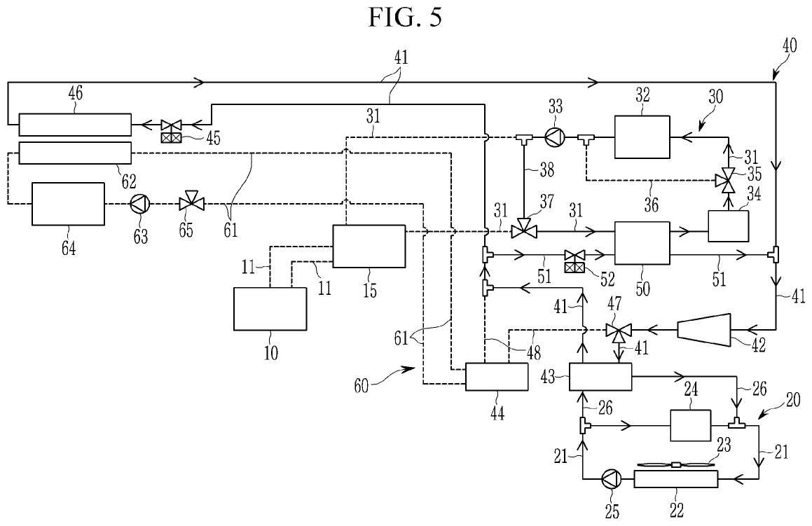

In addition, an operation in the cooling mode of the vehicle interior of the thermal management system for a fuel cell electric vehicle according to an embodiment is described with reference to FIG. 5.

FIG. 5 is an operation diagram of a cooling mode of the thermal management system of a fuel cell electric vehicle according to an embodiment.

Referring to FIG. 5, in the cooling mode of the vehicle interior, the stack cooling apparatus 10 closes the first line 11 such that the first coolant is not supplied to the heat-exchanger 15.

In the electrical component cooling apparatus 20, the second coolant circulates along the second line 21 and the connection line 26 by the operation of the first water pump 25.

In the battery cooling apparatus 30, the third coolant may circulate along the third line 31 by the operation of the second water pump 33.

Here, the first branch line 36 is closed by the operation of the first valve 35. At the same time, the second branch line 38 is opened by the operation of the second valve 37.

In addition, the second valve 37 may close the portion of the third line 31 connected to the heat-exchanger 15.

Accordingly, the third coolant circulates along the opened third line 31 and the second branch line 38 without passing through the heat-exchanger 15.

That is, in the battery cooling apparatus 30, the third coolant heated while cooling the battery 32 may pass through the chiller 50.

In the air conditioner unit 40, corresponding components are operated to circulate the refrigerant. Accordingly, the refrigerant circulates along the refrigerant line 41.

Here, the refrigerant line 41 that connects the evaporator 46 and the first condenser 43 is opened by an operation of the first expansion valve 45. In addition, the first refrigerant connection line 51 may be opened by the operation of the second expansion valve 52.

In addition, the refrigerant valve 47 may close the second refrigerant connection line 48 such that the refrigerant supplied from the compressor 42 does not flow to the second condenser 44.

Then, the refrigerant supplied by the compressor 42 passes through the first condenser 43 along the refrigerant line 41. Here, the heating apparatus 60 may stop operating.

Accordingly, the first condenser 43 may condense the refrigerant supplied from the compressor 42 by heat-exchange with the second coolant supplied from the electrical component cooling apparatus 20.

The refrigerant condensed by the first condenser 43 may be circulated along the refrigerant line 41 and the first refrigerant connection line 51.

Here, the first and second expansion valves 45 and 52 may expand the refrigerant such that the expanded refrigerant is supplied to the evaporator 46 and the chiller 50, respectively.

Meanwhile, the third coolant having passed through the chiller 50 circulates along the third line 31 and the second branch line 38 in order to cool the battery 32 by the operation of the second water pump 33.

The third coolant passing through the chiller 50 is cooled by heat-exchange with the expanded refrigerant supplied to the chiller 50. The third coolant cooled at the chiller 50 is supplied to the battery 32. Accordingly, the battery 32 is cooled by the cooled third coolant.

That is, the second expansion valve 52 expands a portion of the refrigerant having passed through the first condenser 43 to supply the expanded refrigerant to the chiller 50 and opens the first refrigerant connection line 51.

Therefore, the portion of the refrigerant discharged by the first condenser 43 is expanded by the operation of the second expansion valve 52 to become in a state of a low temperature and a low pressure and flows into the chiller 50 connected to the first refrigerant connection line 51.

Then, the refrigerant drawn into the chiller 50 is heat-exchanged with the third coolant and flows into the compressor 59 along the refrigerant line 41 connected to the first refrigerant connection line 51.

Accordingly, within the chiller 50, the third coolant heated while cooling the battery 32 is cooled through heat-exchange with the refrigerant of the low temperature and the low pressure. The cooled third coolant is supplied back to the battery 32 along the third line 31 and the second branch line 38.

That is, the third coolant circulating the battery cooling apparatus 30 may efficiently cool the battery 32 while repetitively performing the above-described operation.

Meanwhile, a remaining refrigerant discharged by the first condenser 43 flows through the refrigerant line 41 for cooling of the vehicle interior and sequentially passes through the first expansion valve 45, the evaporator 46, the compressor 59, and the first condenser 43.

Here, the ambient air drawn into the HVAC module (not shown) is cooled by the low temperature state refrigerant drawn into the evaporator 46 while passing through the evaporator 46. Therefore, the cooled ambient air is directly drawn into the vehicle interior to cool the vehicle interior.

In the cooling mode of the vehicle, the refrigerant may cool the vehicle interior by repetitively performing the above-described processes, and at the same time, may pass through the chiller 50 to cool the third coolant through heat-exchange.

The low temperature third coolant cooled at the chiller 50 flows into the battery 32. Accordingly, the battery 32 may be efficiently cooled by the supplied low temperature third coolant.

Therefore, according to the thermal management system for a fuel cell electric vehicle according to an embodiment, by using the waste heat of the fuel cell stack for adjusting a temperature of a battery and for heating of the vehicle interior, the temperature of the battery 32 may be adjusted more rapidly, and the vehicle interior may be efficiently heated.

In addition, according to embodiments of the present disclosure, by applying the heat-exchanger 15 for heat-exchange between the first and third coolants such that the stack cooling apparatus 10 and the battery cooling apparatus 30 are thermally interlinked, the heat generated by the fuel cell stack may be efficiently used. Accordingly, unnecessary power consumption may be reduced, and marketability may be enhanced.

In addition, according to embodiments of the present disclosure, by efficiently cooling the battery 32 by using the chiller 50 heat-exchanging the refrigerant and the third coolant, a radiator used for the battery in the conventional battery cooling apparatus may be removed, and thereby the overall system may be streamlined.

In addition, according to embodiments of the present disclosure, by using the waste heat of the fuel cell stack and the waste heat of the battery 32 together for heating of the vehicle interior, the overall travel distance of vehicle may be increased by the efficient temperature adjustment of the battery 32 to ensure the optimal performance of the battery 32 and to enhance the heating efficiency.

In addition, according to embodiments of the present disclosure, by streamlining the entire system, reduction of an overall manufacturing cost and a decrease in weight is enabled, and space utilization may be enhanced by minimizing the required components.

While embodiments of this invention have been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A thermal management system for a fuel cell electric vehicle, the system comprising:
a stack cooling apparatus comprising a first line through which a first coolant circulates;
an electrical component cooling apparatus comprising a second line through which a second coolant circulates;
an electrical component on the second line;
a battery cooling apparatus comprising a third line through which a third coolant circulates, wherein the stack cooling apparatus and the battery cooling apparatus are connected to the first line in order to selectively heat-exchange the first coolant supplied from the stack cooling apparatus through the first line with the third coolant circulating along the third line and are thermally interlinked with each other through a heat-exchanger on the third line;
a battery on the third line;
a chiller on the third line, connected through a refrigerant line and a first refrigerant connection line of an air conditioner unit, and configured to adjust a temperature of the third coolant by heat-exchanging the third coolant drawn through the third line with a refrigerant supplied from the air conditioner unit through the first refrigerant connection line;
a heating apparatus comprising a heating line through which a fourth coolant circulates to heat a vehicle interior by using the fourth coolant; and
a heater core on the heating line.

2. The system of claim 1, wherein the air conditioner unit comprises:
a compressor configured to compress the refrigerant;
a first condenser connected to the compressor through the refrigerant line and configured to condense the refrigerant by heat-exchanging the refrigerant supplied from the compressor with the second coolant supplied from the electrical component cooling apparatus;
a first expansion valve connected to the first condenser through the refrigerant line; and
an evaporator connected to the first condenser through the refrigerant line and configured to evaporate the refrigerant by heat-exchanging the refrigerant supplied from the first condenser with ambient air.

3. The system of claim 2, wherein the electrical component cooling apparatus comprises:
a radiator on the second line;
a first water pump on the second line between the radiator and the electrical component;
a cooling fan at a rear of the radiator; and
a connection line comprising a first end connected to the second line between the first water pump and the electrical component and a second end connected to the second line between the electrical component and the radiator, wherein the first condenser is on the connection line.

4. The system of claim 2, wherein the air conditioner unit further comprises:
a refrigerant valve on the refrigerant line between the compressor and the first condenser;
a second refrigerant connection line connected to the refrigerant valve and configured to be selectively opened and closed by an operation of the refrigerant valve;
a second condenser on the second refrigerant connection line, connected to the heating line, and configured to condense the refrigerant by heat-exchanging the refrigerant supplied through the second refrigerant connection line with the fourth coolant supplied from the heating line; and
a second expansion valve on the first refrigerant connection line at an upstream side of the chiller.

5. The system of claim 4, wherein, in a heating mode of the vehicle interior, the refrigerant valve is configured to open the second refrigerant connection line and close the refrigerant line connected to the first condenser.

6. The system of claim 4, wherein a second end of the second refrigerant connection line is connected to the refrigerant line between the first condenser and the first expansion valve.

7. The system of claim 4, wherein, to cool the battery using the third coolant heat-exchanged with the refrigerant, the second expansion valve is configured to expand the refrigerant drawn through the first refrigerant connection line and flow the expanded refrigerant to the chiller.

8. The system of claim 4, wherein the heating apparatus comprises:
a third water pump on the heating line between the second condenser and the heater core;
a coolant heater on the heating line between the third water pump and the heater core and configured to selectively heat the fourth coolant circulating along the heating line;
a third valve on the heating line between the second condenser and the third water pump; and
a third branch line comprising a first end connected to the third valve and a second end connected to the heating line connecting the heater core and the second condenser.

9. The system of claim 8, wherein, to heat the vehicle interior using the coolant heater, the third valve is configured to close a portion of the heating line connected to the second condenser and open the third branch line.

10. A thermal management system for a fuel cell electric vehicle, the system comprising:
a stack cooling apparatus comprising a first line through which a first coolant circulates;
an electrical component cooling apparatus comprising a second line through which a second coolant circulates;
an electrical component on the second line;
a battery cooling apparatus comprising a third line through which a third coolant circulates, wherein the stack cooling apparatus and the battery cooling apparatus are connected to the first line in order to selectively heat-exchange the first coolant supplied from the stack cooling apparatus through the first line with the third coolant circulating along the third line and are thermally interlinked with each other through a heat-exchanger on the third line, the battery cooling apparatus further comprising:
a second water pump on the third line between a battery on the third line and the heat-exchanger;
a first valve on the third line between the battery and a chiller on the third line, wherein the chiller is connected through a refrigerant line and a first refrigerant connection line of an air conditioner unit and is configured to adjust a temperature of the third coolant by heat-exchanging the third coolant drawn through the third line with a refrigerant supplied from the air conditioner unit through the first refrigerant connection line;
a first branch line comprising a first end connected to the first valve and a second end connected to the third line between the battery and the second water pump;
a second valve provided on the third line between the heat-exchanger and the chiller; and
a second branch line comprising a first end connected to the second valve and a second end connected to the third line between the second water pump and the heat-exchanger;
a heating apparatus comprising a heating line through which a fourth coolant circulates to heat a vehicle interior by using the fourth coolant; and
a heater core on the heating line.

11. The system of claim 10, wherein:
the first valve is configured to selectively open the first branch line in order to prevent a temperature of the battery from increasing above a target temperature; and
the third coolant having passed through the chiller is diverted without passing through the battery.

12. The system of claim 10, wherein, when a requested heating temperature is low at a time of heating the vehicle interior, the second valve is configured to close a portion of the third line connected to the heat-exchanger and open the second branch line such that the battery cooling apparatus defines an independent closed circuit separate from the stack cooling apparatus.

13. The system of claim 10, further comprising a battery heater on the third line between the chiller and the first valve.

14. The system of claim 13, wherein, to increase a temperature of the battery, the battery heater is configured to be operated to heat the third coolant supplied to the battery along the third line.

15. The system of claim 10, wherein a heating mode to heat the vehicle interior comprises:
a first heating mode in which a temperature of the battery is increased and waste heat of a fuel cell stack and waste heat of the battery together are recollected;
a second heating mode in which the waste heat of the fuel cell stack is recollected; and
a third heating mode in which the waste heat of the battery is recollected.

16. The system of claim 15, wherein, in the first heating mode:
the first branch line is closed by an operation of the first valve; and
the second branch line is closed by an operation of the second valve.

17. The system of claim 15, wherein, in the second heating mode:
the first branch line is opened by an operation of the first valve;
a portion of the third line connecting the first valve and the battery with reference to the first valve is closed by the operation of the first valve; and
the second branch line is closed by an operation of the second valve.

18. The system of claim 15, wherein, in the third heating mode:
the first branch line is closed by an operation of the first valve;
the second branch line is opened by an operation of the second valve; and
a portion of the third line connected to the heat-exchanger is closed by the operation of the second valve.

19. The system of claim 15, wherein the chiller is configured to:
in the first heating mode, recollect the waste heat of the fuel cell stack and the battery from the third coolant heat-exchanged with the first coolant at the heat-exchanger;
in the second heating mode, recollect the waste heat of the fuel cell stack from the third coolant heat-exchanged with the first coolant at the heat-exchanger; and
in the third heating mode, recollect the waste heat of the battery from the third coolant heated while cooling the battery.
